(19) United States
(12) Patent Application Publication
(10) Pub. No.: US 2006/0019152 A1
(43) Pub. Date: Jan. 26, 2006

(54) Non-aqueous electrolyte battery

(76) Inventors: Naoki Imachi, Kobe-shi (JP); Yasuo Takano, Kobe-shi (JP); Seiji Yoshimura, Kobe-shi (JP); Shin Fujitani, Kobe-shi (JP)

Correspondence Address: KUBOVCIK & KUBOVCIK, SUITE 710, 900 17TH STREET NW, WASHINGTON, DC, 20006, US

(21) Appl. No.: 11/184,905

(22) Filed: Jul. 20, 2005

(30) Foreign Application Priority Data
Jul. 21, 2004 (JP) 2004-213112

(51) Int. Cl. H01M 4/02; H01M 4/52; H01M 4/50

(52) U.S. Cl. 429/128; 429/231.1; 429/224; 429/223; 429/231.3

(57) ABSTRACT

A non-aqueous electrolyte battery is provided that can prevent working voltage of the battery from decreasing even when the battery is stored in high temperature conditions. A non-aqueous electrolyte battery includes: a positive electrode having a positive electrode active material-layer and a positive electrode current collector, a negative electrode having a negative electrode active material layer; and a separator interposed between the electrodes. The positive electrode active material-layer is formed on a positive electrode current collector surface and includes a plurality of layers having different positive electrode active materials, wherein a lowermost layer of the plurality of layers that is in contact with the positive electrode current collector contains as its main active material a positive electrode active material having the lowest end-of-charge working voltage among the positive electrode active materials.

### BACKGROUND OF THE INVENTION

1. Field of the Invention

The present invention relates to improvements in non-aqueous electrolyte batteries, such as lithium-ion batteries and polymer batteries, and more particularly to non-aqueous electrolyte batteries that can improve discharge characteristics even after the batteries have been stored at high temperatures.

2. Description of Related Art

Rapid advancements in size and weight reductions of mobile information terminal devices such as mobile telephones, notebook computers, and PDAs in recent years have created demands for higher capacity batteries as the device power sources. With their high energy density and high capacity, non-aqueous electrolyte batteries that perform charging and discharging by transferring lithium ions between the positive and negative electrodes have been widely used as the device power sources for the mobile information terminal devices. Moreover, utilizing their characteristics, applications of the non-aqueous electrolyte batteries, especially Li-ion batteries, have recently been broadened to middle-sized to large-sized batteries for power tools, electric automobiles, hybrid automobiles, etc., as well as mobile applications such as mobile telephones.

In this kind of non-aqueous electrolyte battery, both the positive and negative electrodes are in an active state during charge, so oxidation and reduction occur between the electrolyte solution and the positive and negative electrodes. In a high temperature condition, side reactions that do not normally occur at room temperature can take place in addition to intercalation and deintercalation of lithium. For that reason, the battery deteriorates severely when used as a power source for mobile telephones or the like in an environment in which the temperature can become very high, such as in an automobile compartment in summer (for example, the temperature in an automobile compartment can become 80° C. or higher). In particular, a problem of a decrease in the battery's working voltage arises when the positive electrode undergoes deterioration.

Many of the non-aqueous electrolyte batteries, especially Li-ion batteries, adopt lithium cobalt oxide as their positive electrode active material. The energy that can be attained by lithium cobalt oxide, however, has almost already reached the limit. Therefore, to achieve higher battery capacity, it has been inevitable to increase the filling density of the positive electrode active material, making more serious the problem of a decrease in the working voltage due to damages to the positive electrode.

In view of the foregoing problem, a technique has been proposed of using a mixture of lithium cobalt oxide and lithium manganese oxide for a positive electrode active material. (See Japanese Published Unexamined Patent Application No. 2001-143705, for example.)

A problem with the foregoing conventional technique is, however, that merely mixing lithium cobalt oxide and lithium manganese oxide cannot fully exploit the advantageous properties of lithium manganese oxide and is insufficient to prevent a decrease in the working voltage of the battery.

### BRIEF SUMMARY OF THE INVENTION

Accordingly, it is an object of the present invention to provide a non-aqueous electrolyte battery that can prevent the working voltage of the battery from decreasing even when the battery is stored under high temperature conditions.

In order to accomplish the foregoing and other objects, the present invention provides a non-aqueous electrolyte battery comprising: a positive electrode having a positive electrode active material-layer and a positive electrode current collector, the positive electrode active material-layer being formed on a positive electrode current collector surface and comprising a plurality of layers having different positive electrode active materials, wherein a lowermost layer of the plurality of layers that is in contact with the positive electrode current collector contains as its main active material a positive electrode active material having the lowest end-of-charge working voltage among the positive electrode active materials; a negative electrode having a negative electrode active material layer; and a separator interposed between the electrodes.

When a battery is stored, the positive electrode active material that can produce a higher working voltage at the end of charge is more prone to damage. On the other hand, regarding the contour of discharge curve of the battery, the positive electrode active material that is located near the positive electrode current collector tends to affect the contour of battery discharge curve to a greater extent than the positive electrode active material near the positive electrode surface. Accordingly, allowing the lowermost positive electrode layer contain as its main active material a positive electrode active material having the lowest working voltage at the end of charge among the positive electrode active materials means that the positive electrode active material that is less prone to damage during battery storage is arranged nearer the positive electrode current collector, resulting in a smaller voltage drop in the final stage of discharge.

In the non-aqueous electrolyte battery of the invention, the main active material of the positive electrode active material in the lowermost positive electrode layer may be a spinel-type lithium manganese oxide.

A spinel-type lithium manganese oxide can produce a low working voltage at the end of charge. Therefore, the advantageous effects as described above can be exhibited more effectively.

In the non-aqueous electrolyte battery of the invention, the positive electrode active material of the lowermost positive electrode layer may consist of spinel-type lithium manganese oxide.

This configuration enables the spinel-type lithium manganese oxide to exhibit the advantages more effectively.

In the non-aqueous electrolyte battery of the invention, the main active material in the positive electrode active material of the lowermost positive electrode layer may be lithium nickel oxide.

The lithium nickel oxide can produce a particularly lower working voltage at the end of charge. Therefore, the advantageous effects as described above can be exhibited more effectively.

In the non-aqueous electrolyte battery of the invention, the positive electrode active material of the lowermost positive electrode layer may consist of lithium nickel oxide.

This configuration enables the lithium nickel oxide to exhibit its advantages more effectively.

In the non-aqueous electrolyte battery of the invention, the positive electrode active material-layer may contain lithium cobalt oxide as a positive electrode active material.

Lithium cobalt oxide has a large capacity per unit volume. Therefore, it is possible to enhance battery capacity when the positive electrode active material-layer contains lithium cobalt oxide as a positive electrode active material as described above.

In the non-aqueous electrolyte battery of the invention, the lithium cobalt oxide may exist in a layer or layers other than the lowermost positive electrode layer.

Lithium cobalt oxide can produce a high working voltage at the end of charge and is therefore more prone to damage. However, when the lithium cobalt oxide exists in a layer or layers other than the lowermost positive electrode layer, it does not affect the contour of battery discharge curve. Consequently, it is possible to prevent voltage drop at the final stage of discharge.

In the non-aqueous electrolyte battery of the invention, the total mass of the lithium cobalt oxide within the positive electrode active material-layer may be greater than the total mass of the spinel-type lithium manganese oxide or lithium nickel oxide within the positive electrode active material-layer.

Restricting the total mass of the lithium cobalt oxide within the positive electrode active material-layer to be greater than the total mass of the spinel-type lithium manganese oxide or lithium nickel oxide within the positive electrode active material-layer, as described above, can enhance the energy density of the battery as a whole because lithium cobalt oxide has a greater specific capacity than spinel-type lithium manganese oxide or the like.

Thus, the present invention achieves a remarkable improvement in battery discharge characteristics after high-temperature storage.

### BRIEF DESCRIPTION OF THE DRAWINGS

FIG. 1 is a graph illustrating discharge characteristics of Battery A of the invention;

FIG. 2 is a graph illustrating discharge characteristics of Comparative Battery X1;

FIG. 3 is a graph illustrating discharge characteristics of Comparative Battery X2;

FIG. 4 is a graph illustrating charge-discharge characteristics of a spinel-type lithium manganese oxide (LMO) and lithium cobalt oxide (LCO);

FIG. 5 is a graph illustrating discharge characteristics of Battery B of the invention; and

FIG. 6 is a graph illustrating discharge characteristics of Comparative Battery Y.

### DETAILED DESCRIPTION OF THE INVENTION

Hereinbelow, the present invention is described in further detail based on preferred embodiments thereof. It should be construed, however, that the present invention is not limited to the following preferred embodiments and various changes and modifications are possible without departing from the scope of the invention.

Preparation of Positive Electrode

First, a spinel-type lithium manganese oxide (hereinafter also abbreviated as “LMO”), used as a positive electrode active material, and SP300 (conductive agent: made by Nippon Graphite Industries, Ltd.) and acetylene black, used as carbon conductive agents, were mixed together at a mass ratio of 92:3:2 to prepare a positive electrode mixture powder. Next, 200 g of the resultant powder was charged into a mixer (for example, a mechanofusion system AM-15F made by Hosokawa Micron Corp.), and the mixer was operated at a rate of 1500 rpm for 10 minutes to cause compression, shock, and shear actions while mixing, to prepare a positive electrode active material mixture. Subsequently, the resultant positive electrode active material mixture and a fluoropolymer-based binder agent (PVDF) were mixed at a mass ratio of 97:3 in N-methyl-2-pyrrolidone (NMP) solvent to prepare a positive electrode slurry. Thereafter, the positive electrode slurry was applied onto both sides of an aluminum foil, serving as a positive electrode current collector, and the resultant material was then dried and pressure-rolled. Thus, a first positive electrode active material layer was formed on a surface of the positive electrode current collector.

Subsequently, another positive electrode slurry was prepared in the same manner as described above except that lithium cobalt oxide (hereinafter also abbreviated as “LCO”) was used as the positive electrode active material. Further, the positive electrode slurry was applied onto the first positive electrode active material layer, and the resultant material was dried and pressure-rolled, whereby a second positive electrode active material layer was formed on the first positive electrode active material layer.

The foregoing procedure resulted in a positive electrode. The mass ratio of the respective positive electrode active materials in the positive electrode was LCO:LMO=65:35.

Preparation of Negative Electrode

A carbon material (graphite), CMC (carboxymethylcellulose sodium), and SBR (styrene-butadiene rubber) were mixed in an aqueous solution at a mass ratio of 98:1:1 to prepare a negative electrode slurry. Thereafter, the negative electrode slurry was applied onto both sides of a copper foil serving as a negative electrode current collector, and the resultant material was then dried and rolled. Thus, a negative electrode was prepared.

Preparation of Non-aqueous Electrolyte Solution

LiPF6 was chiefly dissolved at a concentration of 1.0 mole/L in a mixed solvent of 3:7 volume ratio of ethylene carbonate (EC) and diethyl carbonate (DEC) to prepare a non-aqueous electrolyte solution.

Construction of Battery

Lead terminals were attached to the positive and negative electrodes, and the positive and negative electrodes were wound in a spiral form with a polyethylene separator interposed therebetween. The wound electrodes were then pressed into a flat shape to obtain a power-generating element, and thereafter, the power-generating element was accommodated into an enclosing space made by an aluminum laminate film serving as a battery case. Then, the non-aqueous electrolyte solution was filled into the space, and thereafter the battery case was sealed by welding the aluminum laminate film. Thus, a battery was fabricated.

The foregoing battery had a design capacity of 650 mAh.

### DESCRIPTION OF PREFERRED EMBODIMENTS

### First Embodiment

### EXAMPLE A

A battery fabricated according to the above-described manner was used for Example A.

The battery thus fabricated is hereinafter referred to as Battery A of the invention.

### COMPARATIVE EXAMPLE X1

A battery was fabricated in the same manner as in Example A, except that the positive electrode active material-layer did not have a two-layer structure but had a single layer structure (the positive electrode active material of which was a mixture of LCO and LMO).

The battery thus fabricated is hereinafter referred to as Comparative Battery X1.

### COMPARATIVE EXAMPLE X2

A battery was fabricated in the same manner as in Example A, except that LCO was used for the positive electrode active material of the first positive electrode active material layer (a layer nearer the positive electrode current collector) and LMO was used for the positive electrode active material of the second positive electrode active material layer (a layer on the positive electrode surface side).

The battery thus fabricated is hereinafter referred to as Comparative Battery X2.

Experiment

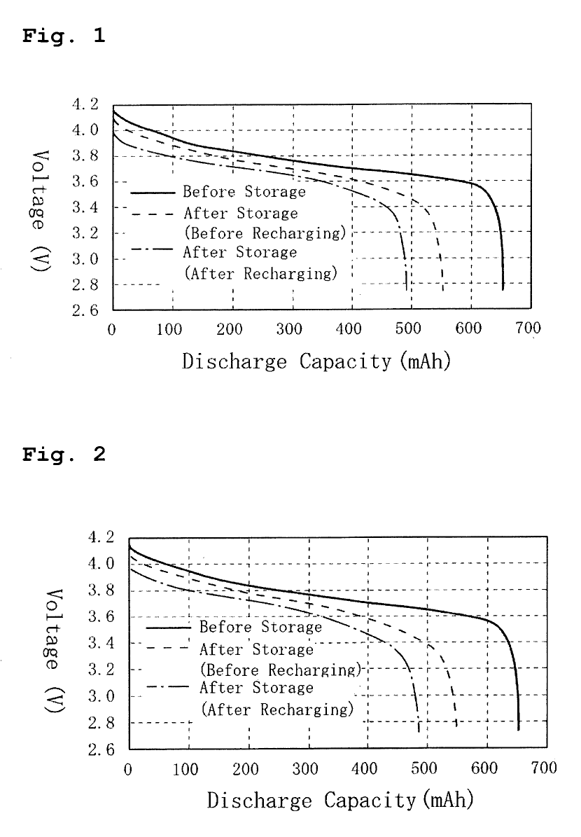

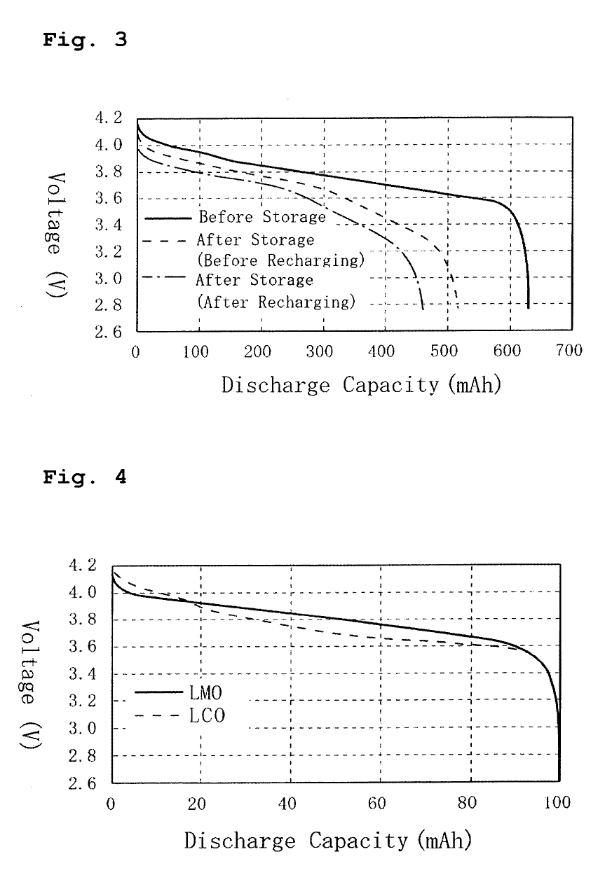

The battery characteristics of Battery A of the invention and Comparative Batteries X1 and X2 before and after high-temperature storage were studied. The results are set forth in Table 1, FIG. 1 (Battery A of the invention), FIG. 2 (Comparative Battery X1), and FIG. 3 (Comparative Battery X2). Specific conditions of the experiment were as follows.

First, the batteries were charged and discharged under the conditions set forth below to examine their discharge characteristics. Next, the batteries were stored under the conditions set forth below and thereafter their discharge characteristics were examined again. Lastly, the batteries were charged and discharged again under the conditions set forth below, and their discharge characteristics were studied. (See FIGS. 1 to 3.)

Charge-discharge Conditions

The batteries were charged at a constant current of 1C (650 mA) until the battery voltage reached 4.2 V and then charged at a constant voltage of 4.2 V until the current became 1/20 C (32.5 mA).

The batteries were discharged at a constant current of 1 C (650 mA) until the battery voltage reached 2.75 V.

A 10-minute resting period was provided between the charging and the discharging.

Storage Conditions

The batteries charged under the above charge conditions were stored for 4 days in an atmosphere at 80° C.

Also, the decreases in initial voltage after the storage with respect to battery voltage before the storage, the internal resistance increases, and the capacity retention ratios and the capacity recovery ratios that are defined by the following equations (1) and (2) were investigated with the batteries. (See Table 1.)

Capacity retention ratio=Discharge capacity after storage/Discharge capacity before storage×100 (%).

Capacity recovery ratio=Discharge capacity after storage and subsequent recharge/Discharge capacity before storage×100 (%)

TABLE 1

| | Voltage | | | |
|---|---|---|---|---|
| | decrease at | | | |
| | initial | Internal | Capacity | Capacity |
| | stage of | resistance | retention | recovery |
| | discharge | increase | ratio | ratio |
| Battery | (V) | (mΩ) | (%) | (%) |
| Battery A | 0.12 | 17.2 | 75.6 | 84.6 |
| Comparative | 0.12 | 11.9 | 74.8 | 84.3 |
| Battery X1 | | | | |
| Comparative | 0.12 | 16.6 | 73.4 | 82.0 |
| Battery X2 | | | | |

FIG. 1 clearly demonstrates that Battery A of the invention exhibited a small voltage drop at the final stage of discharge (after the discharge capacity exceeded about 300 mAh) both before and after the recharging of the battery subsequent to the high-temperature storage. In contrast, as clearly seen from FIGS. 2 and 3, Comparative Batteries X1 and X2 showed large voltage drops at the final stage of discharge both before and after the recharging of the battery subsequent to the high-temperature storage. In particular, Comparative Battery X2 showed a very large voltage drop at the final stage of discharge. This is believed to be due to the following reasons.

Specifically, when a battery is stored at a high temperature, a positive electrode active material that produces a higher working voltage at the end of charge is more prone to damage. If this is the case, it is inferred that LCO is damaged primarily while LMO undergoes almost no damage in both Battery A of the invention and Comparative Batteries X1 and X2. The reason is that, as clearly seen from FIG. 4 the comparison between the charge-discharge curves of LCO and LMO indicates that LCO shows a higher working voltage at the end of charge than LMO. On the other hand, the present inventors have found that the positive electrode active material nearer the positive electrode current collector tends to affect the contour of battery discharge curve more than the positive electrode active material on the surface side of the positive electrode.

In Battery A of the invention, LMO, which is a positive electrode active material less prone to damage, is arranged near the positive electrode current collector while LCO, which is a positive electrode active material more prone to damage, is arranged on the surface side of the positive electrode; therefore, in Battery A of the invention, LMO affects the contour of the battery discharge curve to a greater extent, resulting in a small voltage drop at the final stage of discharge. By contrast, in Comparative Battery X1, LMO, which is less prone to damage, and LCO, which is more prone to damage, are arranged both near the positive electrode current collector and on the surface side of the positive electrode. Therefore, in Comparative Battery X1, both LCO and LMO affect the contour of the battery discharge curve, resulting in a greater voltage drop at the final stage of discharge. Furthermore, in Comparative Battery X2, LCO, which is the positive electrode active material more prone to damage, is arranged near the positive electrode current collector while LMO, which is the positive electrode active material less prone to damage, is arranged on the surface side of the positive electrode. Therefore, in Comparative Battery X2, LCO affects the contour of battery discharge curve to a greater extent, resulting in an even greater voltage drop at the final stage of discharge.

Table 1 also shows that there was no difference in voltage decrease at the initial stage of discharge between Battery A of the invention and Comparative Battery X1, and also that there was little difference in their capacity retention ratios and their capacity recovery ratios. It is believed that the reason is that Battery A of the invention showed an increase in the battery internal resistance, as clearly seen from Table 1, although its voltage drop at the final stage of discharge was small, while Comparative Battery X1 did not show a considerable increase in the battery internal resistance, although its voltage drop at the final stage of discharge was great. It is believed that the reason why the internal resistance in Battery A of the invention increased is that the amount of binder agent at the interface between the first positive electrode active material layer and the second positive electrode active material layer was greater than that in the rest of the regions. In Comparative Battery X2, the capacity retention ratio and the capacity recovery ratio were lower than those of Battery A of the invention and Comparative Battery X1. This is because, in Comparative Battery X2, the voltage drop at the final stage of discharge was great and moreover, as clearly seen from Table 1, the battery internal resistance increased.

### Second Embodiment

### EXAMPLE B

A battery was fabricated in the same manner as in Example A in the first embodiment, except that in place of LMO, lithium nickel oxide (LiNi_{0.8}Co_{0.2}O₂, hereinafter also abbreviated as LNO) was used as the positive electrode active material in the first positive electrode active material layer and that the mass ratio of the positive electrode active materials in the positive electrode was LCO:LNO=70:30.

The battery thus fabricated is hereinafter referred to as Battery B of the invention.

### COMPARATIVE EXAMPLE Y

A battery was fabricated in the same manner as in Comparative Example X1 in the first embodiment, except that in place of LMO, LNO was used as the positive electrode active material in the positive electrode active material-layer and that the mass ratio of the positive electrode active materials in the positive electrode was LCO:LNO=70:30.

The battery thus fabricated is hereinafter referred to as Comparative Battery Y.

Experiment

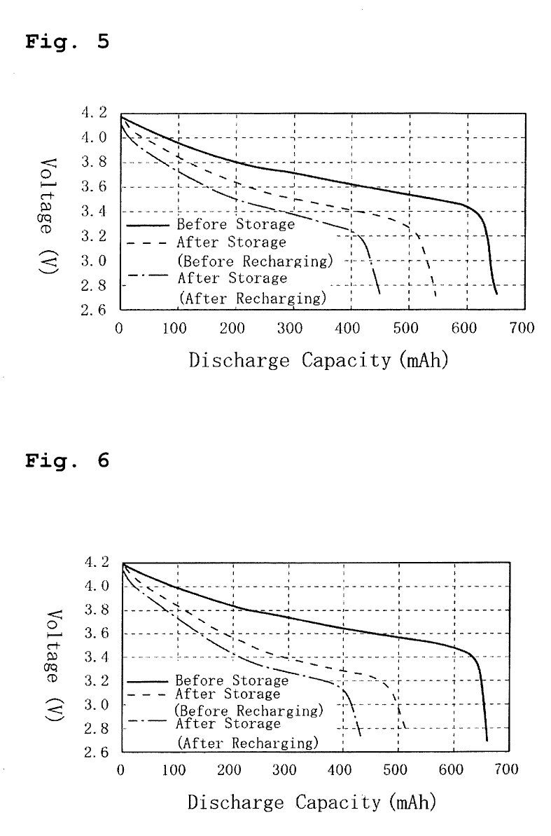

The battery characteristics of Battery B of the invention and Comparative Battery Y before and after high-temperature storage were studied. The results are set forth in Table 2, FIG. 5 (Battery B of the invention), and FIG. 6 (Comparative Battery Y). Specific conditions of the experiment were the same as those of the experiment in first embodiment.

TABLE 2

| | Voltage | | | |
|---|---|---|---|---|
| | decrease at | | | |
| | initial | Internal | Capacity | Capacity |
| | stage of | resistance | retention | recovery |
| | discharge | increase | ratio | ratio |
| Battery | (V) | (mΩ) | (%) | (%) |
| Battery B | 0.10 | 18.4 | 69.6 | 84.2 |
| Comparative | 0.10 | 15.6 | 65.5 | 77.9 |
| Battery Y | | | | |

As clearly seen from FIG. 5, Battery B of the invention exhibited a small voltage drop at the final stage of discharge (after the discharge capacity exceeded about 300 mAh) both before and after the recharging of the battery subsequent to the high-temperature storage. In contrast, as clearly seen from FIG. 6, Comparative Battery Y showed a large voltage drop both before and after the recharging of the battery subsequent to the high-temperature storage. It is believed that the results are due to the same reasons as discussed in the experiment in the first embodiment.

Table 2 also clearly demonstrates that although there was no difference in voltage drop at the initial stage of discharge between Battery B of the invention and Comparative Battery Y, Battery B of the invention exhibited improved capacity retention ratio and capacity recovery ratio over those of Comparative Battery Y. The reason is believed to be as follows. With Battery B of the invention, the voltage drop at the final stage of discharge was small, and moreover, as clearly seen from Table 2, an increase in the battery internal resistance was prevented. In contrast, with Comparative Battery Y, the voltage drop at the final stage of discharge was great, and moreover, as clearly seen from Table 2, the increase in battery internal resistance was similar to that of Battery B of the invention.

Other Variations

(1) The positive electrode active material is not limited to lithium cobalt oxide, spinel-type lithium manganese oxide, and lithium nickel oxide. Other materials may be used such as an olivine-type lithium phosphate and a layered lithium-nickel compound. The working voltage at the end of charge for these positive electrode active materials is as shown in Table 3. Herein, it is necessary that a positive electrode active material that shows a low working voltage at the end of charge be selected for the first positive electrode active material layer (the layer nearer the positive electrode current collector).

TABLE 3

| Type of positive electrode | Working voltage at |
|---|---|
| active material | end of charge* |
| Lithium cobalt oxide | Highest |
| (LiCoO₂) | |
| Spinel-type lithium manganese | Low |
| oxide (LiMn₂O₄) | |
| Lithium nickel oxide | Fairly high |
| (LiNiO₂) | |
| Olivine-type lithium iron | Very low |
| phosphate (LiFePO₄) | |
| Layered lithium-nickel | Fairly high |
| compound | |
| (LiNi_{1/3}Mn_{1/3}Co_{1/3}O₂) | |

*Working voltages at the end of charge shown are relative to that of lithium cobalt oxide.

(2) In the foregoing examples, a spinel-type lithium manganese oxide or lithium nickel oxide is used alone as the active material of the first positive electrode active material layer, but such a configuration is merely illustrative of the invention. For example, it is of course possible to use a mixture of spinel-type lithium manganese oxide and lithium nickel oxide for the active material of the first positive electrode active material layer. Likewise, it is also possible to use a mixture for the second positive electrode active material layer.

(3) The structure of the positive electrode is not limited to the two-layer structure, and a structure comprising three or more layers may of course be employed.

(4) The method for mixing the positive electrode mixture is not limited to the above-noted mechanofusion method. Other possible methods include a method in which a mixture is dry-blended while milling the mixture with a Raikai-mortar, and a method in which the mixture is wet-mixed and dispersed directly in a slurry.

(5) The negative electrode active material is not limited to graphite, and various other materials may be employed, such as coke, tin oxides, metallic lithium, silicon, and mixtures thereof, as long as the materials are capable of intercalating and deintercalating lithium ions.

(6) The lithium salt in the electrolyte solution is not limited to the LiPF₆, and various other substances may be used, including LiBF₄, LiN(SO₂CF₃)₂, LiN(SO₂C₂F₅)₂, LiPF_{6-X}(CnF₂ₙ₊₁)_{X} (wherein 1<x<6 and n=1 or 2), which may be used either alone or in combination of two or more of them. The concentration of the lithium salt is not particularly limited, but it is preferable that the concentration of the lithium salt be restricted in the range of from 0.8 moles to 1.5 moles per 1 liter of the electrolyte solution. The solvents for the electrolyte solution are not particularly limited to ethylene carbonate (EC) and diethyl carbonate (DEC) mentioned above, and preferable solvents include carbonate solvents such as propylene carbonate (PC), γ-butyrolactone (GBL), ethyl methyl carbonate (EMC), and dimethyl carbonate (DMC). More preferable is a combination of a cyclic carbonate and a chain carbonate.

(7) The present invention may be applied to gelled polymer batteries as well as liquid-type batteries. In this case, examples of the polymer material include polyether-based solid polymer, polycarbonate solid polymer, polyacrylonitrile-based solid polymer, oxetane-based polymer, epoxy-based polymer, and copolymers or cross-linked polymers comprising two or more of these polymers, as well as PVDF. A gelled solid electrolyte in which any of these polymer materials, a lithium salt, and an electrolyte are combined may be used.

The present invention is also applicable to large-sized batteries for, for example, in-vehicle power sources for electric automobiles or hybrid automobiles, as well as the device power sources for mobile information terminals such as mobile telephones, notebook computers, and PDAs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority based on Japanese patent application No. 2004-213112, filed Jul. 21, 2004, which is incorporated herein by reference.

What is claimed is:

1. A non-aqueous electrolyte battery comprising:
a positive electrode having a positive electrode active material-layer and a positive electrode current collector, the positive electrode active material-layer being formed on a positive electrode current collector surface and comprising a plurality of layers having different positive electrode active materials, wherein a lowermost layer of the plurality of layers that is in contact with the positive electrode current collector contains as its main active material a positive electrode active material having the lowest end-of-charge working voltage among the positive electrode active materials;
a negative electrode having a negative electrode active material layer; and
a separator interposed between the electrodes.

2. The non-aqueous electrolyte battery according to claim 1, wherein the main active material of the positive electrode active material in the lowermost positive electrode layer is a spinel-type lithium manganese oxide.

3. The non-aqueous electrolyte battery according to claim 1, wherein the positive electrode active material of the lowermost positive electrode layer consists of spinel-type lithium manganese oxide.

4. The non-aqueous electrolyte battery according to claim 1, wherein the main active material in the positive electrode active material of the lowermost positive electrode layer is lithium nickel oxide.

5. The non-aqueous electrolyte battery according to claim 1, wherein the positive electrode active material of the lowermost positive electrode layer consists of lithium nickel oxide.

6. The non-aqueous electrolyte battery according to claim 1, wherein the positive electrode active material-layer contains lithium cobalt oxide as a positive electrode active material.

7. The non-aqueous electrolyte battery according to claim 6, wherein the lithium cobalt oxide exists in a layer or layers other than the lowermost positive electrode layer.

8. The non-aqueous electrolyte battery according to claim 6, wherein the positive electrode active material-layer contains spinel-type lithium manganese oxide or lithium nickel oxide and the total mass of the lithium cobalt oxide within the positive electrode active material-layer is greater than the total mass of the spinel-type lithium manganese oxide or lithium nickel oxide within the positive electrode active material-layer.

9. The non-aqueous electrolyte battery according to claim 7, wherein the positive electrode active material-layer contains spinel-type lithium manganese oxide or lithium nickel oxide and the total mass of the lithium cobalt oxide within the positive electrode active material-layer is greater than the total mass of the spinel-type lithium manganese oxide or lithium nickel oxide within the positive electrode active material-layer.
